(19) United States
(12) Patent Application Publication
(10) Pub. No.: US 2026/0356418 A1
(43) Pub. Date: Nov. 12, 2026

(54) DRIVING OPERATION APPARATUS AND VEHICLE HAVING THE SAME

(71) Applicants: Hyundai Motor Company, Seoul (KR); Kia Corporation, Seoul (KR); LS Automotive Technologies Co., Ltd., Anyang-si (KR)

(72) Inventors: Eun Sik KIM, Hwaseong-Si (KR); Hun Jung, Anyang-Si (KR); Ki Nyeong Ko, Anyang-Si (KR); Jung Jae Lee, Anyang-Si (KR)

(73) Assignees: Hyundai Motor Company, Seoul (KR); Kia Corporation, Seoul (KR); LS Automotive Technologies Co., Ltd., Anyang-si (KR)

(21) Appl. No.: 19/405,931

(22) Filed: Dec. 2, 2025

(30) Foreign Application Priority Data
May 7, 2025 (KR) 10-2025-0059267

(51) Int. Cl. B62D 1/12; B60K 26/02; B60K 35/22; B60T 7/08; B62D 1/16

(52) U.S. Cl. CPC B62D 1/12; B60K 26/02; B60K 35/22; B60T 7/08; B62D 1/16

(57) ABSTRACT

In a driving operation apparatus and a vehicle including the same, driving operation systems for steering, acceleration, and braking are integrated into a single system together with a display to form a module, which allows for weight reduction and cost savings by reducing the number of components and maximizes the utilization of an internal space.

### CROSS-REFERENCE TO RELATED APPLICATION(S)

The present application is based on and claims priority under 35 U.S.C. 119 to Korean Patent Application No. 10-2025-0059267, filed on May 7, 2025, the present disclosure of which is herein incorporated by reference in its entirety.

### BACKGROUND OF THE PRESENT DISCLOSURE

### Field of the Present Disclosure

Embodiments disclosed herein relate to a driving operation apparatus and a vehicle including the same. More particularly, the embodiments relate to a driving operation apparatus, in which a driving operation system for steering, acceleration, and braking is integrated into a single system together with a display to form a module, and to a vehicle including the same.

### Description of Related Art

A self-driving vehicle is a smart vehicle incorporating autonomous driving technology that allows it to independently navigate to a destination without requiring the driver to manually operate the steering wheel, accelerator pedal, or brake.

When autonomous driving is widely implemented, it may be possible to select between a manual driving mode, in which the driver operates the vehicle directly, and an autonomous driving mode, in which the vehicle drives itself to the destination without driver intervention.

A driving operation system of a self-driving vehicle may typically include a steering operation system, an acceleration operation system, and a braking operation system. A general driving operation system is configured so that the operation systems for steering, acceleration, and braking are each provided separately. As a result, the number of components increases, separate installation spaces are required, and there are significant spatial constraints and concerns about increased costs.

The foregoing described as the background art is intended merely to aid in the understanding of the background of embodiments set forth herein, and should not be construed as meaning that the embodiments fall within the purview of the related art already known to those skilled in the art.

### BRIEF SUMMARY

In various aspects of the present disclosure, the present disclosure is to provide a driving operation apparatus, in which a driving operation system for steering, acceleration, and braking is integrated into a single system together with a display to form a module, which allows for a reduction in the number of components, which in turn enables weight reduction and cost savings, and minimizing the layout required for installation space to maximize the utilization of internal space.

In various aspects of the present disclosure, a driving operation apparatus configured in a display-integrated type, may help enhance passenger entertainment in an autonomous driving mode and provide vehicle information and surrounding information in a manual driving mode, improving convenience and safety.

The technical subjects pursued in embodiments set forth herein may not be limited to the above-mentioned technical subjects, and other technical subjects which are not mentioned herein may be clearly understood from the following description by those skilled in the art to which the exemplary embodiments pertain.

In view of the foregoing, a driving operation apparatus includes: a rotary housing through which a center shaft fixed to a vehicle mounting unit passes and which is configured to rotate about the center shaft relative to the vehicle mounting unit during a steering operation; a fixed housing fixedly coupled to the center shaft which passes through the rotary housing, and disposed to be inserted into the rotary housing; a display unit coupled to the fixed housing; and a pair of driving operation systems disposed on opposite sides of the display unit and each including one end portion fixed to the rotary housing and the other end portion protruding toward a driver and configured to allow the driver to perform steering, acceleration, and braking operations.

The display unit is coupled to the fixed housing to face rearward toward the driver, and in a state in which the fixed housing is coupled to the rotary housing, the display unit is coupled to protrude further toward the driver than a rear surface of the rotary housing.

The driving operation systems protrude further toward the driver than the display unit to prevent the driver's hand from interfering with the display unit when the user holds and operates the driving operation systems.

When the driver holds the driving operation systems and rotates the rotary housing, the vehicle's steering function is executed.

Each driving operation system includes an acceleration operation system configured to implement an acceleration function and a braking operation system configured to implement a braking function when operated by the driver.

Each driving operation system includes: a body portion disposed at a first end portion of the driving operation system and fixedly coupled to the rotary housing; a handle portion disposed at a second end portion of the driving operation system and configured for the driver to perform the steering operation by holding and rotating the rotary housing clockwise or counterclockwise; and a connecting portion protruding from the body portion toward the driver and connected to the handle portion. The acceleration operation system and the braking operation system are disposed between the handle portion and the connecting portion.

The braking operation system is disposed on a central axis that passes through a center portion of the handle portion in a longitudinal direction of the handle portion, and the acceleration operation system is disposed at a position spaced inwardly from the braking operation system toward a center portion of the display unit.

An acceleration operation recess and a braking operation recess are disposed below the acceleration operation system and the braking operation system, respectively, into which the driver's finger is inserted, the acceleration operation recess and the braking operation recess are disposed side by side therebetween, and between the acceleration operation recess and the braking operation recess, a protrusion is disposed to form a boundary between the acceleration operation recess and the braking operation recess.

The vehicle mounting unit includes an arc-shaped receiving portion, the rotary housing includes an arc-shaped insertion portion, which is inserted into and embedded in the arc-shaped receiving portion, and through which the center shaft passes, and the arc-shaped insertion portion rotates clockwise and counterclockwise with respect to the arc-shaped receiving portion during the steering operation in the inserted state of the arc-shaped insertion portion to the arc-shaped receiving portion.

The rotary housing includes an arc-shaped housing insertion portion at a center portion thereof, the fixed housing is inserted into the housing insertion portion and coupled to the center shaft, and the rotary housing rotates clockwise and counterclockwise without interfering with the fixed housing during the steering operation.

A second circle that connects external arcs of the display unit has a diameter which is relatively greater than a diameter of a first circle that connects arcs of the housing insertion portion, the first circle is contained within the second circle, and the display unit continuously covers the housing insertion portion regardless of the rotation of the rotary housing caused by the steering operation to prevent the housing insertion portion from being exposed externally.

The driving operation apparatus further includes an elastic member including a first end portion connected to the rotary housing and a second end portion connected to the center shaft to provide a restoring force to the rotary housing during the rotation of the rotary housing caused by the steering operation.

The elastic member includes: a first return spring including a first end portion connected to the rotary housing and a second end portion connected to a first spring bracket coupled to the center shaft; and a second return spring including a first end portion connected to the rotary housing and a second end portion connected to a second spring bracket coupled to the center shaft. The first return spring and the second return spring are assembled symmetrically in tension and compression so that when the rotary housing rotates, one of the first return spring and the second return spring is tensioned while a remaining one is compressed, and vice versa.

The driving operation apparatus further includes a damper assembly, through which the center shaft passes and which is connected to the rotary housing and the fixed housing. The damper assembly is configured to generate a damping force in a direction opposite to a rotation direction of the rotary housing.

The damper assembly includes: a sun gear connected to the rotary housing to rotate together with the rotary housing; and a plurality of rotary damper gears rotatably coupled to a first holder connected to the fixed housing, and engaged with the sun gear.

The driving operation apparatus may further include a magnetic gear rotatably coupled to a second holder, which is connected to the fixed housing, the magnetic gear being engaged with the sun gear and including a magnet therein; and a steering PCB disposed in a damper housing, which is coupled to the fixed housing, to face the magnetic gear, the steering PCB being configured to detect a change in magnetic flux generated during the rotation of the magnetic gear due to the steering operation and to generate a signal related to a steering function of a vehicle.

The rotary damper gears are disposed at equal intervals along the circumferential surface of the sun gear, and a damping force is generated by oil resistance inside each rotary damper gear as it rotates.

The vehicle mounting unit includes an arc-shaped receiving portion, the rotary housing includes an arc-shaped insertion portion, which is inserted into and embedded in the arc-shaped receiving portion, and through which the center shaft passes, and the rotary housing includes an arc-shaped housing insertion portion at a center portion thereof. The fixed housing is inserted into the housing insertion portion and coupled to the center shaft, the arc-shaped insertion portion and the housing insertion portion are disposed coaxially with respect to the center shaft, the arc-shaped insertion portion is disposed in front of the housing insertion portion, and the arc-shaped insertion portion has a diameter greater than that of the housing insertion portion.

The driving operation system includes a left driving operation system and a right driving operation system, and a connecting portion of the left driving operation system and a connecting portion of the right driving operation system, which protrude from the rotary housing, are connected to the rotary housing to protrude in a U-shape. The connecting portions of the left and right driving operation systems are disposed radially outside the display unit to prevent the driver's hand from interfering with the display unit when the driver holds the handle portion.

In various aspects of the present disclosure, a vehicle including: a driving operation system including a rotary housing through which a center shaft fixed to a vehicle mounting unit passes and which is configured to rotate about the center shaft relative to the vehicle mounting unit during a steering operation, a fixed housing fixedly coupled to the center shaft that passes through the rotary housing and disposed to be inserted into the rotary housing, a display unit coupled to the fixed housing, and a pair of driving operation systems disposed on opposite sides of the display unit and each including a first end portion fixed to the rotary housing and a second end portion protruding toward a driver, the driving operation systems being configured to allow the driver to perform steering, acceleration, and braking operations; and a vehicle controller configured to generate an operation signal corresponding to a signal generated by the driving operation systems. The vehicle is driven in response to the operation signal from the driving operation systems.

With a driving operation in various aspects of the present disclosure, a driving operation system for steering, acceleration, and braking is integrated into a single system together with a display to form a module, which allows for a reduction in the number of components, which in turn enables weight reduction and cost savings, and minimizing the layout required for installation space. As a result, it is possible to maximize the utilization of internal space.

Furthermore, in various aspects of the present disclosure, when performing another action such as operating the Audio, Video and Navigation (AVN) or opening a door window using one hand, a driver may simultaneously perform steering, acceleration, and braking operations using the other hand through the driving operation systems. As a result, it is possible to enhance safety.

Furthermore, in various aspects of the present disclosure, a driving operation apparatus is configured in a display-integrated type, which helps enhance passenger entertainment in an autonomous driving mode and provides vehicle information and surrounding information in a manual driving mode. As a result, it is possible to improve convenience and safety.

Furthermore, in various aspects of the present disclosure, the display unit is configured to remain fixed without rotating even when the driver performs a steering operation by rotating the rotary housing using the driving operation systems. As a result, it is possible for the driver to comfortably and reliably check the information disposed by the fixed display unit.

Advantageous effects obtainable from embodiments set forth herein may not be limited to the above-mentioned effects, and other effects which are not mentioned herein may be clearly understood from the following description by those skilled in the art to which the embodiments pertain.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is an exploded view of a driving operation apparatus according to an exemplary embodiment disclosed herein;

FIG. 2 is a view corresponding to FIG. 1 in an assembled state;

FIG. 3 is a plan view of FIG. 2;

FIG. 4 is a view exemplarily illustrating a state in which a vehicle mounting unit is removed from FIG. 2, and

FIG. 5, FIG. 6, FIG. 7, FIG. 8, FIG. 9, FIG. 10, FIG. 11, FIG. 12, FIG. 13, FIG. 14, FIG. 15, FIG. 16, and FIG. 17 are views exemplarily illustrating detailed configurations of the driving operation apparatus.

### DETAILED DESCRIPTION

In describing the embodiments set forth herein, a detailed description of known functions or configurations incorporated herein will be omitted when it is determined that the description may make the subject matter of the embodiments set forth herein unclear. In addition, it should be appreciated that the accompanying drawings are provided only for the sake of easy understanding of the embodiments set forth herein, and the technical idea of the present disclosure is not limited to the accompanying drawings and includes all modifications, equivalents, or alternatives falling within the spirit and scope of the present disclosure. The following descriptions are not intended to limit the present disclosure to the described form or specific field, and it is considered that various alternative modifications and changes may be made to the present disclosure regardless of whether the descriptions are explicit or implicit. Those skilled in the art to which the present disclosure pertains will appreciate that the contents of the present disclosure may be changed in forms and details.

The present disclosure will be described with reference to specific embodiments. However, as understood by a person ordinarily skilled in the art to which the present disclosure pertains, various aspects disclosed herein may be modified or otherwise implemented in different ways without departing from the spirit and scope of the present disclosure. Accordingly, the following description is to be considered exemplary, and is intended to teach those ordinarily skilled in the art to which the present disclosure belongs how to make and use various embodiments. It is to be understood that the forms of the present disclosure illustrated and described herein are exemplary embodiments. Equivalent elements, materials, processes, or steps may be substituted for those exemplified and described in the present disclosure. Expressions used in the present disclosure, such as “including,” “comprising,” “incorporating,” “consisting of,” “have,” or “is,” should be interpreted in a non-exclusive manner, i.e., to allow for the inclusion of items, components, or elements not explicitly listed. In addition, references to the singular form should be interpreted to include the plural form as well.

Furthermore, the various embodiments disclosed herein should be regarded as exemplary and descriptive, and should not be construed as limiting the scope of the present disclosure. All references to joining (e.g., attached, affixed, coupled, and connected) are used solely to facilitate understanding of the present disclosure and are not intended to limit the position, orientation, or use of any component or method disclosed herein. Accordingly, references to joining should be interpreted broadly. Moreover, these references to joining do not imply that two or more elements are directly connected to each other. Furthermore, all numerical terms, such as “first,” “second,” “third,” “primary,” “secondary,” “main,” or any other generic terms or numerical expressions, are to be understood solely as identifiers to aid in the understanding of the various components, embodiments, modifications, or variations of the present disclosure, and do not imply any limitations as to any component, embodiment, modification, variation, or their order or preference. That is, these terms may be used to describe various components but should not be construed as limiting the components to those terms. These terms are used only to distinguish one component from another.

The terms “module” and “unit” used for the elements in the following description are given or interchangeably used in consideration of only the ease of writing the specification, and do not have distinct meanings or roles by themselves.

In the case where an element is referred to as being “connected” or “coupled” to any other elements, it should be understood that not only the element may be directly connected or coupled to the other elements, but also another element may exist therebetween. Contrarily, in the case where an element is referred to as being “directly connected” or “directly coupled” to any other element, it should be understood that no other element exists therebetween.

Furthermore, a unit or a control unit included in names is merely a term widely used for naming a controller configured to control a specific function of a vehicle, but does not mean a generic function unit.

To control functions in charge, a controller may include a communication device configured to communicate with a sensor or another controller, a memory configured to store an operating system or logic instructions and input/output information, and at least one processor configured to perform determination, calculation, decision, or the like required for control of the functions in charge.

Any number or variety of components in any of the configurations described herein may be included within the scope of the present disclosure described herein. The components may include any combination of the features described herein and may be arranged in any of the various configurations described herein. The concepts related to the structure and arrangement of the components of the present disclosure, as well as their use and operation, may be applied to any number of embodiments in any combination, as well as to the specific embodiments discussed herein. Embodiments including those having various features in various arrangements are described below with reference to the drawings.

Hereinafter, various embodiments set forth herein will be described in detail with reference to the accompanying drawings, and a same or similar elements are given a same and similar reference numerals regardless of figure numbers, so duplicate descriptions thereof will be omitted.

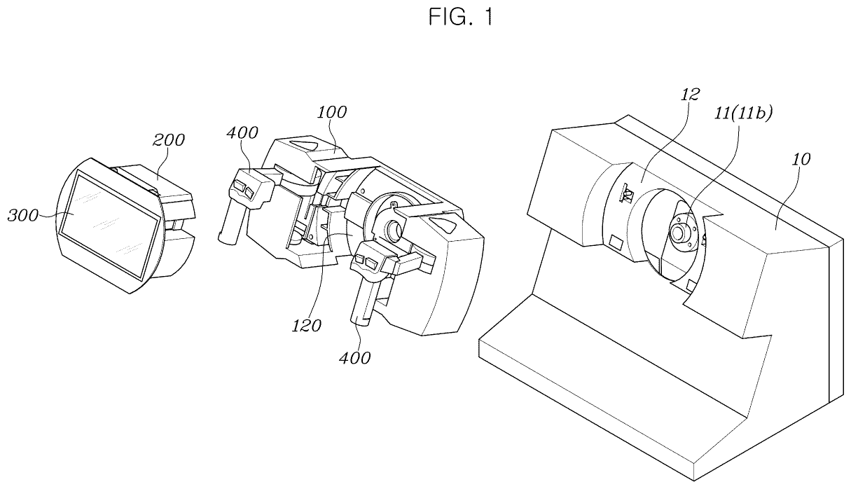

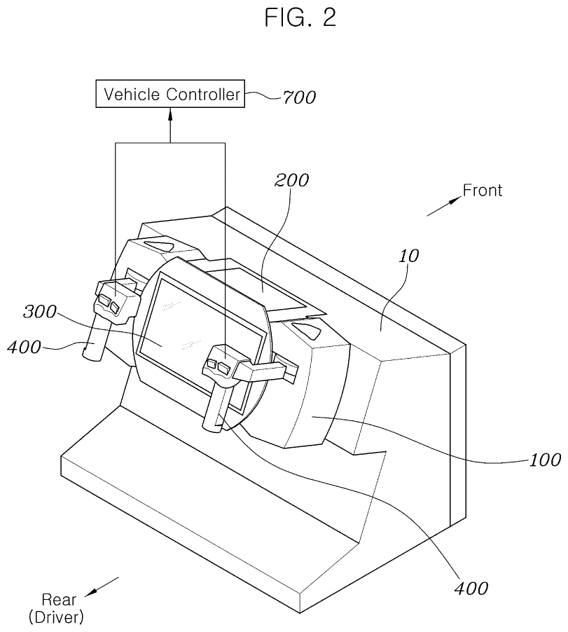

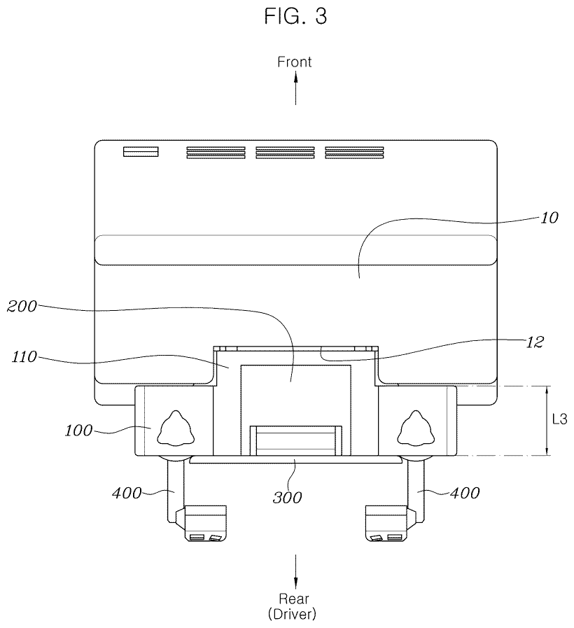

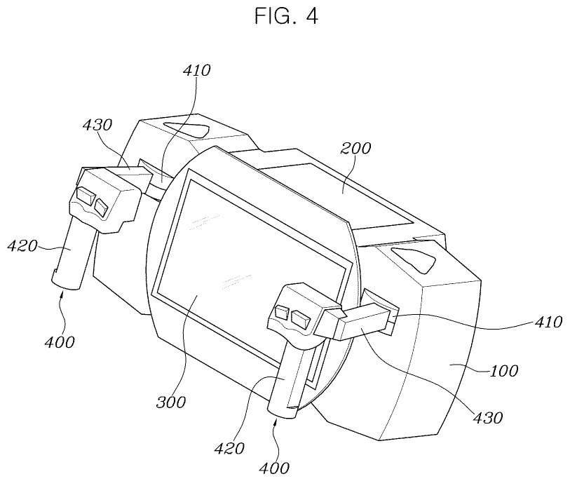

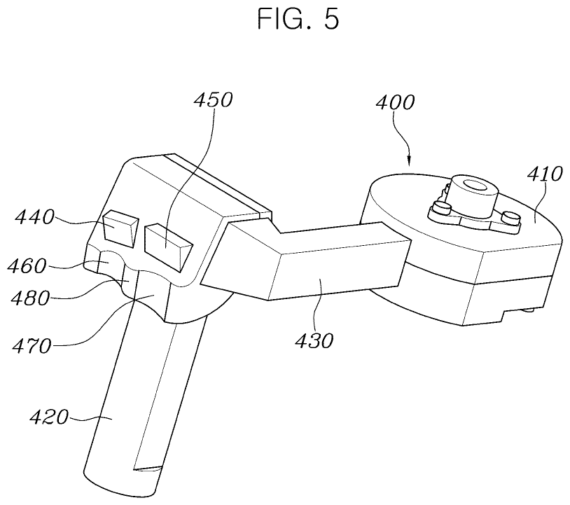

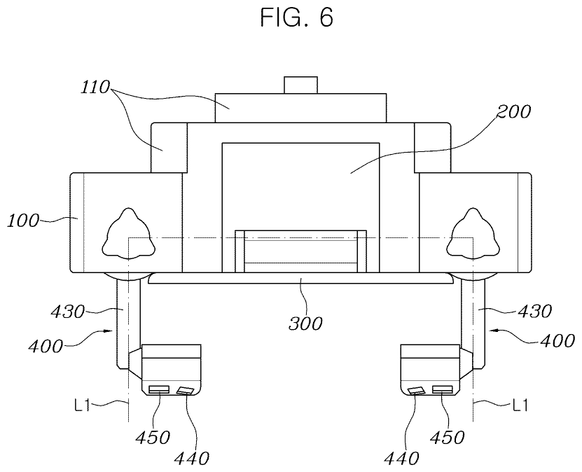

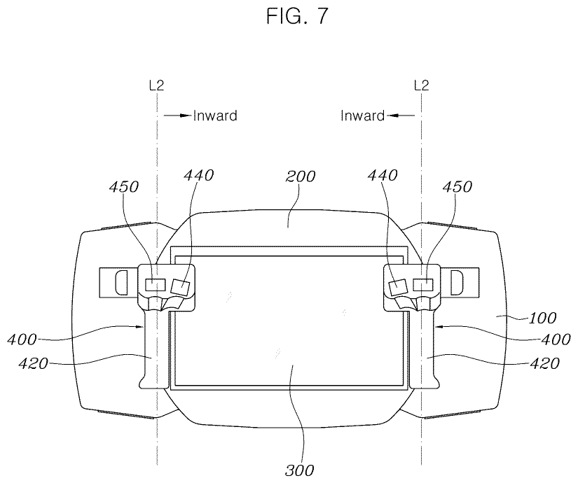

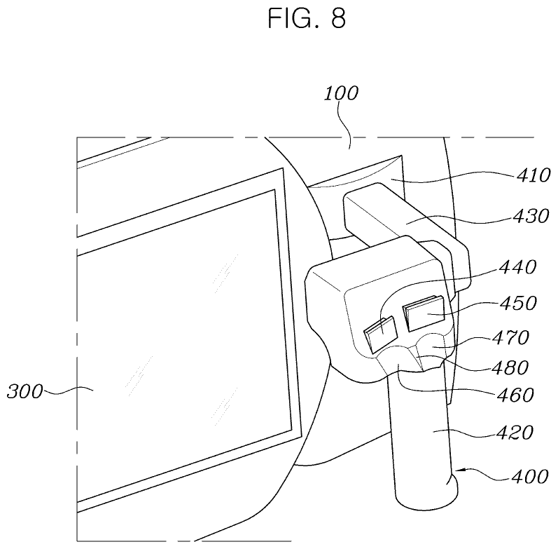

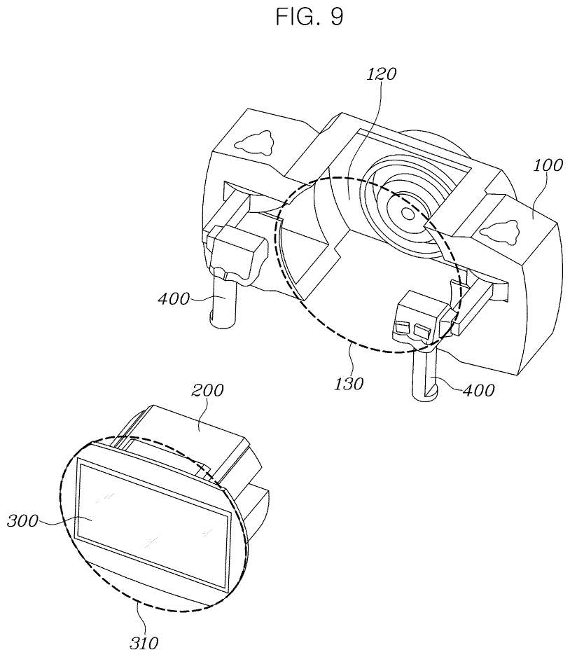

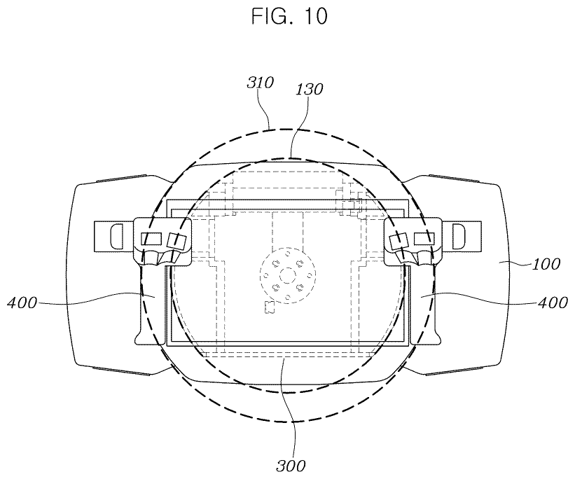

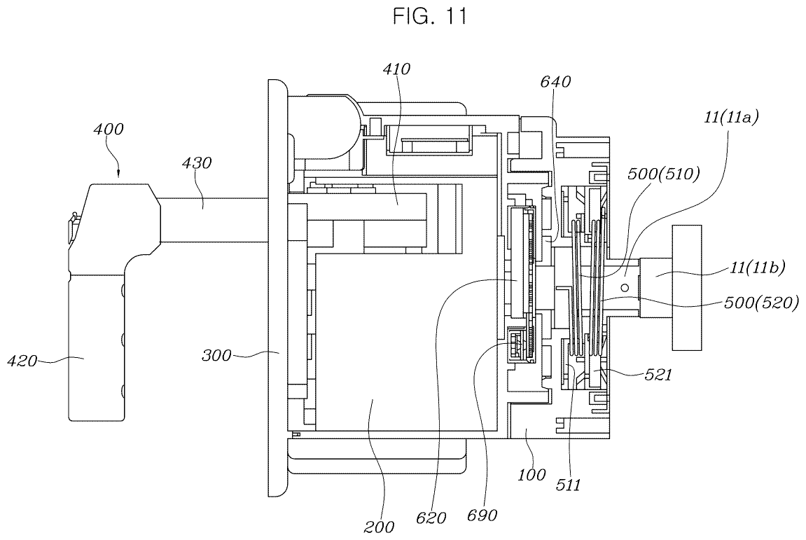

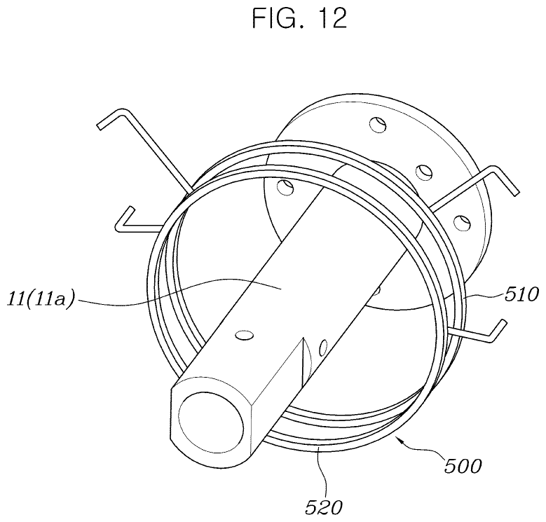

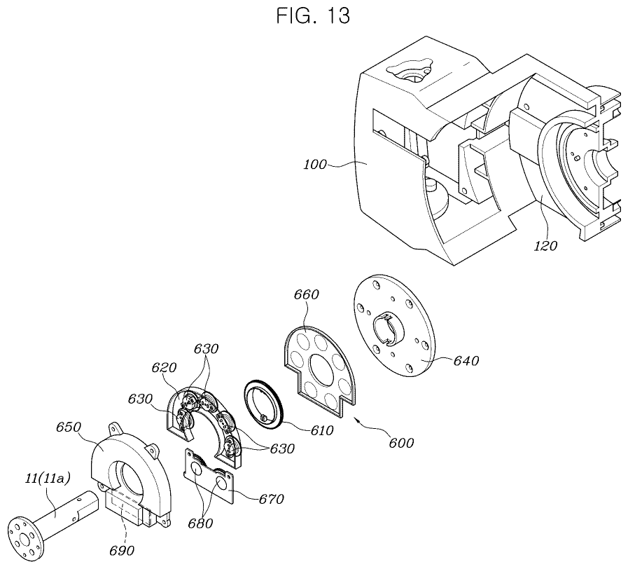

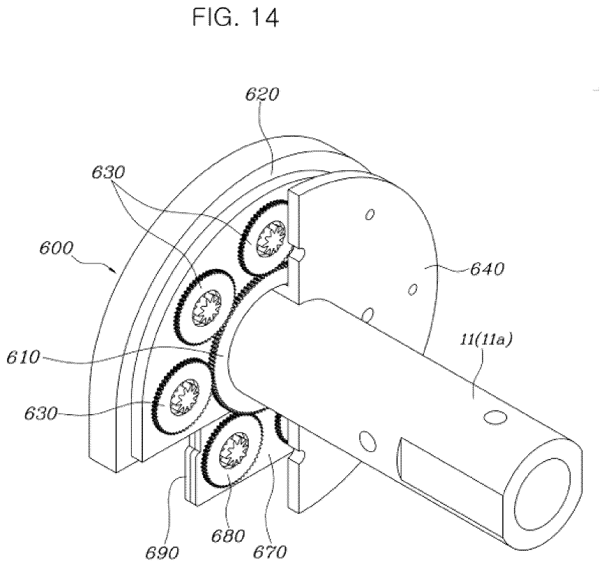

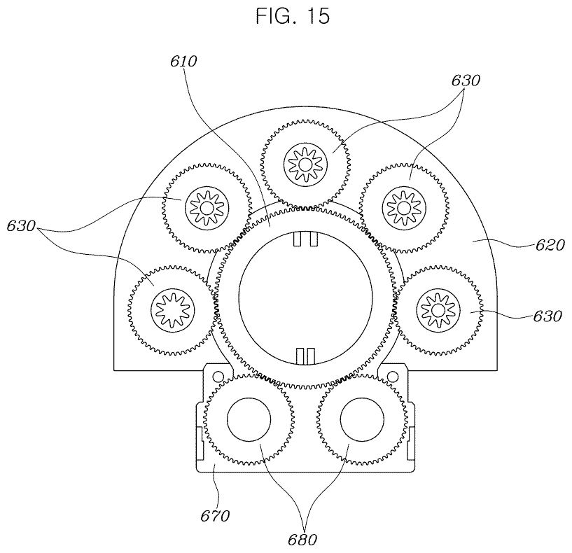

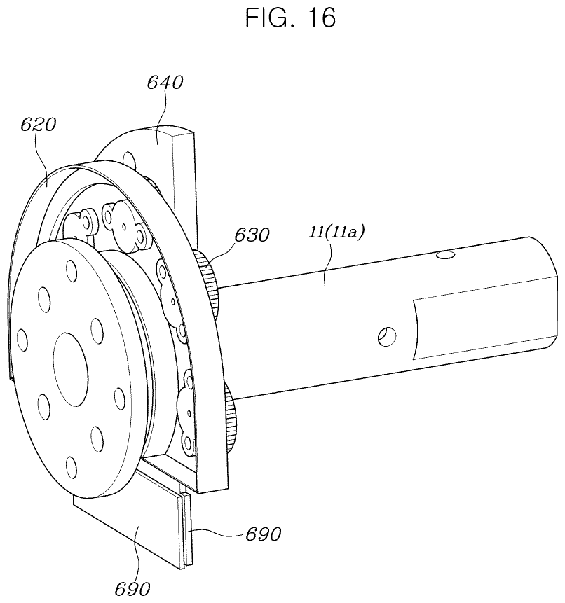

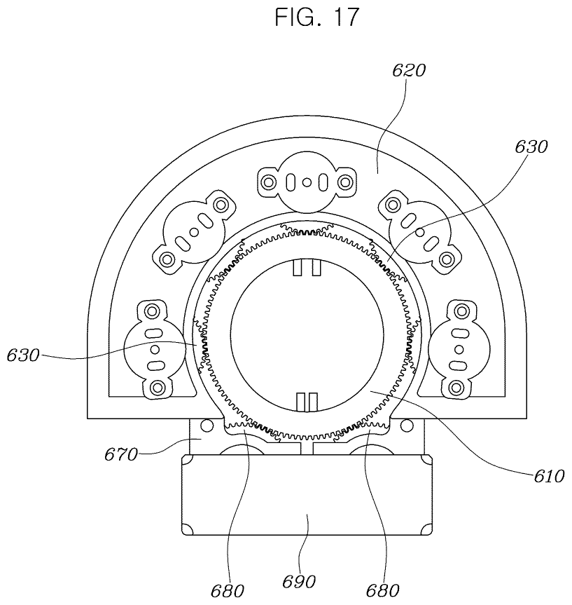

As illustrated in FIGS. 1 to 17, a driving operation apparatus according to an exemplary embodiment disclosed herein may include: a rotary housing 100 through which a center shaft 11 fixed to a vehicle mounting unit 10 passes, the rotary housing 100 being configured to rotate with respect to the vehicle mounting unit 10 about the center shaft 11 during steering operation; a fixed housing 200 fixedly coupled to the center shaft 11 passing through the rotary housing 100 and disposed to be inserted into the rotary housing 100; a display unit 300 coupled to the fixed housing 200; and a pair of driving operation systems 400 disposed on opposite sides of the display unit 300 and each including one end portion fixed to the rotary housing 100 and the other end portion protruding toward a driver. The pair of driving operation systems 400 are configured to be operated by the driver to perform steering, acceleration, and braking operations.

The vehicle mounting unit 10 may be a crash pad in a vehicle interior.

The center shaft 11 may include a first center shaft 11a coupled to the fixed housing 200 and a second center shaft 11b fixed to the vehicle mounting unit 10. When the fixed housing 200 is inserted into a housing insertion portion 120 of the rotary housing 100 and disposed to the vehicle mounting unit 10, the first center shaft 11a and the second center shaft 11b may be coupled to each other to form a single integrated center shaft 11.

When the fixed housing 200 is disposed to the vehicle mounting unit 10, the center shaft 11 passes through a center portion of the rotary housing 100. Accordingly, the rotary housing 100 is configured to rotate clockwise and counterclockwise about the center shaft 11.

During a steering operation, the vehicle mounting unit 10, the fixed housing 200, and the display unit 300 serve as fixed components that do not rotate, and only the rotary housing 100, to which the driving operation systems 400 are coupled, is configured to rotate clockwise and counterclockwise.

The display unit 300 may be coupled to the fixed housing 200 to face rearward toward the driver.

Furthermore, in a state in which the fixed housing 200 is coupled to the rotary housing 100, the display unit 300 may be coupled to protrude further toward the driver than the rear surface of the rotary housing 100.

This may prevent the rotary housing 100 from covering a portion of the display unit 300, allowing the entire screen of the display unit 300 to be visible to the driver and improving visibility.

Even when the driver performs a steering operation by rotating the rotary housing 100 using the driving operation systems 400, the display unit 300 may remain stationary without rotating. As a result, the driver may comfortably and reliably check the information provided by the fixed display unit 300.

One end portion of each of the driving operation systems 400 may be fixedly coupled to the rotary housing 100, and the other end portion may protrude rearward toward the driver.

The rearwardly protruding end portions of the driving operation systems 400 may protrude further toward the driver than the display unit 300 to prevent the driver's hand from interfering with the display unit 300 when holding and operating the driving operation systems 400. This allows the driver to easily perform a steering operation using the driving operation systems 400.

When the driver holds the driving operation systems 400 and rotates the rotary housing 100 clockwise or counterclockwise, the vehicle's steering function may be executed.

Two identical driving operation systems 400 may be disposed in a symmetrical structure on the left and right sides of the display unit 300, and the left and right driving operation systems 400 may be operated by the driver using right and left hands, respectively.

The driver may hold both the left and right driving operation systems 400 to rotate the rotary housing 100, or may rotate the rotary housing 100 by holding only one of the left and right driving operation systems 400, in which case the vehicle's steering function may still be performed.

The driver may perform steering, acceleration, and braking operations using the driving operation systems 400, and may also perform gear shifting if necessary. Gear shifting may be performed using the display unit 300.

When gear shifting is performed using the display unit 300, the display unit 300 may be disposed with a gear shifting system configured to be operated by the driver through finger touch. The gear shifting system may include a Park (P)-position switch, a Reverse (R)-position switch, a Neutral (N)-position switch, and a Drive (D)-position switch.

Each driving operation system 400 may include an acceleration operation system 440 configured to implement an acceleration function and a braking operation system 450 configured to implement a braking function when operated by the driver.

As an exemplary embodiment of the present disclosure, the acceleration operation system 440 and the braking operation system 450 may be configured as button operable by the driver through finger pressing.

Each driving operation system 400 may include: a body portion 410, one end portion of which is fixedly coupled to the rotary housing 100; a handle portion 420 at the other end portion, which is held by the driver and configured to allow steering operation by rotating the rotary housing 100 clockwise or counterclockwise; and a connecting portion 430 that protrudes from the body portion 410 toward the driver and is connected to the handle portion 420.

The acceleration operation system 440 and the braking operation system 450 may be disposed between the handle portion 420 and the connecting portion 430.

While holding the handle portion 420, the driver may rotate the rotary housing 100 clockwise or counterclockwise to perform a steering operation. Accordingly, the handle portion 420 is configured as a steering operation system.

While holding the handle portion 420, the driver may operate the acceleration operation system 440 or the braking operation system 450 using a thumb.

The left driving operation system 400 and the right driving operation system 400 may each include a handle portion 420 for steering operation, an acceleration operation system 440 for acceleration, and a braking operation system 450 for braking.

Referring to FIG. 6, the connecting portion 430 of the left driving operation system 400 and the connecting portion 430 of the right driving operation system 400, which protrude from the rotary housing 100, may be connected to the rotary housing 100 to protrude in a U-shape (C-shape indicated by line L1). The connecting portions of the left and right driving operation systems 400 may be disposed radially outside the display unit 300 to prevent the driver's hand from interfering with the display unit 300 when the driver holds the handle portion 420.

Referring to FIG. 7, the braking operation system 450 may be disposed on a central axis L2 that passes through a center portion of the handle portion 420 in the longitudinal direction of the handle portion 420, and the acceleration operation system 440 may be disposed at a position spaced inwardly from the braking operation system 450 toward a center portion of the display unit 300.

While holding the handle portion 420, the driver may operate the acceleration operation system 440 or the braking operation system 450 with a thumb. By positioning the braking operation system 450 on the central axis L2 of the handle portion 420, the driver may operate the braking operation system 450 easily and accurately in the most comfortable posture.

Furthermore, the acceleration operation system 440 may be disposed inwardly of the braking operation system 450 so that the driver intentionally moves the thumb inward toward the center of the display unit 300 to operate the acceleration operation system 440, preventing unintended operations.

According to the disclosed exemplary embodiment, an acceleration operation recess 460 and a braking operation recess 470 may be disposed below the acceleration operation system 440 and the braking operation system 450, respectively, into which the driver's thumb is inserted into the corresponding recess when the driver operates the acceleration operation system 440 or the braking operation system 450.

The acceleration operation recess 460 and the braking operation recess 470 may be disposed side by side, and between the acceleration operation recess 460 and the braking operation recess 470, a protrusion 480 may protrude to distinguishes the boundary therebetween.

The protrusion 480 may provide a tactile sensation when the driver moves the thumb to operate the acceleration operation system 440 or the braking operation system 450, preventing unintended operation during manipulation of the acceleration operation system 440 or the braking operation system 450.

Permanent magnets may be disposed in the acceleration operation system 440 and the braking operation system 450, respectively, so that when either the acceleration operation system 440 or the braking operation system 450 is operated, an operation system controller (printed circuit board (PCB)) may detect a change in magnetic flux of the permanent magnets and generate a signal related to the acceleration or braking function.

Signals related to steering, acceleration, braking, and gear shifting, generated by the operation system controller, may be transmitted to a vehicle controller.

According to an exemplary embodiment disclosed herein, the vehicle mounting unit 10 may include an arc-shaped receiving portion 12, and the rotary housing 100 may include an arc-shaped insertion portion 110, which is inserted into and embedded in the arc-shaped receiving portion 12, and through which the center shaft 11 passes. The arc-shaped insertion portion 110 may rotate clockwise and counterclockwise with respect to the arc-shaped receiving portion 12 during a steering operation while in the inserted state of the arc-shaped insertion portion 110 to the arc-shaped receiving portion 12.

The arc-shaped insertion portion 110 of the rotary housing 100 may be disposed to be inserted into and embedded in the arc-shaped receiving portion 12 of the vehicle mounting unit 10. Accordingly, during the steering operation, the arc-shaped insertion portion 110 may rotate clockwise and counterclockwise relative to the arc-shaped receiving portion 12.

As the arc-shaped insertion portion 110 is inserted into and embedded in the arc-shaped receiving portion 12, the protruding length L3 of the rotary housing 100 from the vehicle mounting unit 10 may be minimized, improving the utilization of the internal space.

According to an exemplary embodiment disclosed herein, the arc-shaped insertion portion 110 and the housing insertion portion 120 may be disposed coaxially with respect to the center shaft, and the arc-shaped insertion portion 110 may be disposed in front of the housing insertion portion 120. The diameter of the arc-shaped insertion portion 110 may be greater than that of the housing insertion portion 120, further improving the utilization of the internal space and allowing for a reduction in size.

According to an exemplary embodiment disclosed herein, the arc-shaped housing insertion portion 120 may be disposed at a center portion of the rotary housing 100, the fixed housing 200 may be inserted into the housing insertion portion 120 and coupled to the center shaft 11, and the rotary housing 100 may rotate clockwise and counterclockwise without interfering with the fixed housing 200 during the steering operation.

During a steering operation, the rotary housing 100 may rotate clockwise and counterclockwise relative to the vehicle mounting unit 10 and the fixed housing 200.

To the present end, the rotary housing 100 may be disposed with the arc-shaped housing insertion portion 120, and the fixed housing 200 may include an arc-shaped external profile to be insertable into the housing insertion portion 120.

When the fixed housing 200 is inserted into the housing insertion portion 120 of the rotary housing 100 and disposed to the vehicle mounting unit 10, the first center shaft 11a and the second center shaft 11b may be coupled to each other. The center shaft 11, which is formed by the coupling of the first center shaft 11a and the second center shaft 11b, may pass through the center portion of the rotary housing 100, and the rotary housing 100 may rotate clockwise and counterclockwise about the center shaft 11.

The arc-shaped external profile of the fixed housing 200 may be slightly smaller than that of the housing insertion portion 120 to allow, during a steering operation, the rotary housing 100 to smoothly rotate clockwise and counterclockwise without interfering with the fixed housing 200.

Referring to FIG. 9 and FIG. 10, according to an exemplary embodiment disclosed herein, the diameter of a second circle 310 that connects the external arcs of the display unit 300 may be relatively greater than the diameter of a first circle 130 that connects the arcs of the housing insertion portion 120, and the first circle 130 may be contained within the second circle 310.

Accordingly, the display unit 300 may continuously cover the housing insertion portion 120 regardless of the rotation of the rotary housing 100 caused by a steering operation. Thus, the display unit 300 may prevent the housing insertion portion 120 from being exposed externally, which may contribute to enhancing the aesthetic appearance.

Referring to FIG. 11 and FIG. 12, according to an exemplary embodiment disclosed herein, the driving operation apparatus may further include an elastic member 500 including one end portion connected to the rotary housing 100 and the other end portion connected to the center shaft 11 to provide a restoring force to the rotary housing 100 during its rotation caused by the steering operation.

The elastic member 500 may include a first return spring 510 including one end portion connected to the rotary housing 100 and the other end portion connected to a first spring bracket 511 coupled to the first center shaft 11a, and a second return spring 520 including one end portion connected to the rotary housing 100 and the other end portion connected to a second spring bracket 521 coupled to the first center shaft 11a.

The first return spring 510 and the second return spring 520 may be assembled symmetrically in tension and compression so that when the rotary housing 100 rotates, one of the first return spring 510 and the second return spring 520 may be tensioned while the other may be compressed, and vice versa, ensuring steering torque.

When the driver performs a steering operation using the driving operation systems 400, the rotary housing 100 may rotate clockwise or counterclockwise. In the instant case, when the first return spring 510 is compressed or tensioned, the second return spring 520 may be tensioned or compressed accordingly. When the driver releases the steering operation on the rotary housing 100, the rotary housing 100 may return to the neutral position by rotating in the opposite direction due to the spring forces of the first return spring 510 and the second return spring 520.

Referring to FIG. 11 and FIGS. 13 to 17, according to an exemplary embodiment disclosed herein, the driving operation apparatus may further include a damper assembly 600, through which the first center shaft 11a passes and which is connected to the rotary housing 100 and the fixed housing 200. The damper assembly is configured to generate a damping force in a direction opposite to the rotation direction of the rotary housing 100.

The damper assembly 600 may generate a damping force in a direction opposite to the direction of operation during a steering operation, and may also generate a damping force in a direction opposite to the return direction during a return movement. Accordingly, the damping force of the damper assembly 600 may act during the steering operation and during the return.

Due to the damper assembly 600, smooth steering operation may be achieved during the steering operation, and the return speed during the return to the neutral position may be reduced. The damping force of the damper assembly 600 may be proportional to the rotation speed of the rotary housing 100.

The damper assembly 600 may include: a sun gear 610 connected to the rotary housing 100 to rotate together with the rotary housing 100; and a plurality of rotary damper gears 630 rotatably coupled to a first holder 620 connected to the fixed housing 200, and engaged with the sun gear 610.

A sun gear plate 640 may be fixedly coupled to a center portion of rotation of the rotary housing 100, and the sun gear 610 may be fixedly coupled to the sun gear plate 640.

The sun gear plate 640 and the housing insertion portion 120 may be fastened and fixed with bolts, and the sun gear 610 and the sun gear plate 640 may be fastened and fixed through a snap-fit method.

Accordingly, the rotary housing 100, the sun gear plate 640, and the sun gear 610 become rotating components during a steering operation.

A damper housing 650 may be fixedly coupled to the center portion of the fixed housing 200, a first holder 620 may be fixedly coupled to the damper housing 650, and a plurality of rotary damper gears 630 may be rotatably coupled to the first holder 620.

A housing cover 660 may be coupled to the damper housing 650 to protect the first holder 620 and the rotary damper gears 630.

The rotary damper gears 630 may be configured as oil-based dampers, for example, as barrel dampers, and may all be engaged with the sun gear 610.

While the rotary damper gears 630 rotate, the resistance of the oil may reduce the return speed of the rotary housing 100 returning to the neutral position during a steering operation.

The rotary damper gears 630 may be disposed at equal intervals along the circumferential surface of the sun gear 610, and a damping force may be generated by the oil resistance inside each rotary damper gear 630 as it rotates.

According to an exemplary embodiment disclosed herein, the driving operation apparatus may further include: a magnetic gear 680 rotatably coupled to a second holder 670, which is connected to the fixed housing 200, the magnetic gear being engaged with the sun gear 610 and including a magnet therein; and a steering PCB 690 disposed in the damper housing 650, which is coupled to the fixed housing 200, to face the magnetic gear 680, and configured to detect a change in magnetic flux generated during the rotation of the magnetic gear 680 due to the steering operation and to generate a signal related to the steering function of the vehicle.

The second holder 670 may be located below the first holder 620 and may be fixedly coupled to the damper housing 650 connected to the fixed housing 200.

A plurality of magnetic gears 680 may be rotatably coupled to the second holder 670, and may be engaged with the sun gear 610 to rotate together with the sun gear 610.

The plurality of magnetic gears 680 may be disposed to implement the accuracy and redundancy of signals related to the steering function.

The steering PCB 690 may include a non-contact sensor configured to detect a change in magnetic flux caused by the rotation of the magnetic gear 680 according to a steering operation and to generate a signal related to the steering function of the vehicle.

The non-contact sensor may be configured as a Hall sensor, but is not limited thereto.

According to an exemplary embodiment disclosed herein, a vehicle may include: a driving operation system including a rotary housing 100 through which a center shaft 11 fixed to a vehicle mounting unit 10 passes and which is configured to rotate about the center shaft 11 relative to the vehicle mounting unit 10 during a steering operation, a fixed housing 200 fixedly coupled to the center shaft 11 that passes through the rotary housing 100 and disposed to be inserted into the rotary housing 100, a display unit 300 coupled to the fixed housing 200, and a pair of driving operation systems 400 disposed on opposite sides of the display unit 300 and each including one end portion fixed to the rotary housing 100 and the other end portion protruding toward a driver, the driving operation systems being configured to allow the driver to perform steering, acceleration, and braking operations; and a vehicle controller 700 configured to generate an operation signal corresponding to a signal generated by the driving operation systems 400. The vehicle is driven in response to a manipulation signal from the driving operation systems 400.

As described above, with the driving operation apparatus according to an exemplary embodiment disclosed herein, the driving operation systems 400 for steering, acceleration, and braking are integrated into a single modular together with the display 300 to form a module, which allows for weight reduction and cost savings by reducing the number of components, and also minimizes the layout required for installation space. As a result, it is possible to maximize the utilization of the internal space.

Furthermore, according to an exemplary embodiment disclosed herein, when the driver performs another action such as operating the Audio, Video and Navigation (AVN) or opening a door window using one hand, the driver may simultaneously perform steering, acceleration, and braking operations using the other hand through the driving operation systems 400. As a result, it is possible to improve safety.

Furthermore, according to an exemplary embodiment disclosed herein, a driving operation apparatus is configured in a display-integrated type, which helps enhance passenger entertainment in an autonomous driving mode and provides vehicle information and surrounding information in a manual driving mode. As a result, it is possible to improve convenience and safety.

Furthermore, according to an exemplary embodiment disclosed herein, the display unit 300 is configured to remain fixed without rotating even when the driver performs a steering operation by rotating the rotary housing 100 using the driving operation systems 400. As a result, it is possible for the driver to comfortably and reliably check the information disposed through the fixed display unit 300.

Although embodiments set forth herein have been described and illustrated in connection with various exemplary embodiments of the present disclosure, it will be apparent to those skilled in the art that various improvements and modifications may be made to the embodiments set forth herein without departing from the technical idea of the embodiments as defined by the appended claims.

What is claimed is:

1. A driving operation apparatus comprising:
a rotary housing through which a center shaft fixed to a vehicle mounting unit passes, the rotary housing being configured to rotate with respect to the vehicle mounting unit about the center shaft during steering operation;
a fixed housing fixedly coupled to the center shaft passing through the rotary housing and disposed to be inserted into the rotary housing;
a display unit coupled to the fixed housing; and
a pair of driving operation systems disposed on opposite sides of the display unit, wherein each driving operation system includes a first end portion fixed to the rotary housing and a second end portion protruding in a predetermined direction, the pair of driving operation systems operated in response to a driver's activation to perform steering, acceleration, and braking operations.

2. The driving operation apparatus of claim 1,
wherein the display unit is coupled to the fixed housing to face rearward in the predetermined direction, and
wherein in a state in which the fixed housing is coupled to the rotary housing, the display unit is coupled to protrude further in the predetermined direction than a rear surface of the rotary housing.

3. The driving operation apparatus of claim 1,
wherein the driving operation systems protrude further in the predetermined direction than the display unit to prevent the driver's hand from interfering with the display unit based on that the driver holds and operates the driving operation systems.

4. The driving operation apparatus of claim 1,
wherein a steering function of a vehicle is executed in response for the driver's holding the driving operation systems and rotating the rotary housing.

5. The driving operation apparatus of claim 1,
wherein each driving operation system comprises an acceleration operation system configured to implement an acceleration function and a braking operation system configured to implement a braking function in response to operation thereof by the driver.

6. The driving operation apparatus of claim 4,
wherein each driving operation system comprises:
a body portion disposed at a first end portion of the corresponding driving operation system and fixedly coupled to the rotary housing;
a handle portion disposed at a second end portion of the corresponding driving operation system and configured for the driver to perform the steering operation by holding and rotating the rotary housing clockwise or counterclockwise; and
a connecting portion protruding from the body portion in the predetermined direction and connected to the handle portion, and
wherein the acceleration operation system and the braking operation system are disposed between the handle portion and the connecting portion.

7. The driving operation apparatus of claim 6,
wherein the braking operation system is disposed on a central axis that passes through a center portion of the handle portion in a longitudinal direction of the handle portion, and
wherein the acceleration operation system is disposed at a position spaced inwardly from the braking operation system toward a center portion of the display unit.

8. The driving operation apparatus of claim 6, further including:
an acceleration operation recess and a braking operation recess disposed below the acceleration operation system and the braking operation system, respectively, into which the driver's finger is inserted,
wherein the acceleration operation recess and the braking operation recess are disposed side by side therebetween, and
wherein, between the acceleration operation recess and the braking operation recess, a protrusion protrudes to form a boundary between the acceleration operation recess and the braking operation recess.

9. The driving operation apparatus of claim 1,
wherein the vehicle mounting unit comprises an arc-shaped receiving portion,
wherein the rotary housing comprises an arc-shaped insertion portion, which is inserted into and embedded in the arc-shaped receiving portion, and through which the center shaft passes, and
wherein the arc-shaped insertion portion rotates clockwise and counterclockwise with respect to the arc-shaped receiving portion during the steering operation in the inserted state of the arc-shaped insertion portion to the arc-shaped receiving portion.

10. The driving operation apparatus of claim 1,
wherein the rotary housing comprises an arc-shaped housing insertion portion at a center portion thereof,
wherein the fixed housing is inserted into the housing insertion portion and coupled to the center shaft, and
wherein the rotary housing rotates clockwise and counterclockwise without interfering with the fixed housing during the steering operation.

11. The driving operation apparatus of claim 10,
wherein a second circle that connects external arcs of the display unit has a diameter which is greater than a diameter of a first circle that connects arcs of the housing insertion portion,
wherein the first circle is contained within the second circle, and
wherein the display unit continuously covers the housing insertion portion regardless of the rotation of the rotary housing caused by the steering operation to prevent the housing insertion portion from being exposed externally.

12. The driving operation apparatus of claim 1, further comprising:
an elastic member including a first end portion connected to the rotary housing and a second end portion connected to the center shaft to provide a restoring force to the rotary housing during the rotation of the rotary housing caused by the steering operation.

13. The driving operation apparatus of claim 12, wherein the elastic member comprises:
a first return spring including a first end portion connected to the rotary housing and a second end portion connected to a first spring bracket coupled to the center shaft; and
a second return spring including a first end portion connected to the rotary housing and a second end portion connected to a second spring bracket coupled to the center shaft, and
wherein the first return spring and the second return spring are assembled symmetrically in tension and compression so that based on that the rotary housing rotates, one of the first return spring and the second return spring is tensioned while a remaining one of the first return spring and the second return spring is compressed, and vice versa.

14. The driving operation apparatus of claim 1, further comprising:
a damper assembly, through which the center shaft passes and which is connected to the rotary housing and the fixed housing, the damper assembly being configured to generate a damping force in a direction opposite to a rotation direction of the rotary housing.

15. The driving operation apparatus of claim 14, wherein the damper assembly comprises:
a sun gear connected to the rotary housing to rotate together with the rotary housing; and
a plurality of rotary damper gears rotatably coupled to a first holder connected to the fixed housing, and engaged with the sun gear.

16. The driving operation apparatus of claim 15, further comprising:
a magnetic gear rotatably coupled to a second holder, which is connected to the fixed housing, the magnetic gear being engaged with the sun gear and including a magnet therein; and
a steering printed circuit board (PCB) disposed in a damper housing, which is coupled to the fixed housing, to face the magnetic gear, the steering PCB being configured to detect a change in magnetic flux generated during rotation of the magnetic gear due to the steering operation and to generate a signal related to a steering function of a vehicle.

17. The driving operation apparatus of claim 15,
wherein the plurality of rotary damper gears are disposed at equal intervals along a circumferential surface of the sun gear, and
wherein a damping force is generated by oil resistance inside each rotary damper gear as each rotary damper rotates.

18. The driving operation apparatus of claim 1,
wherein the vehicle mounting unit comprises an arc-shaped receiving portion,
wherein the rotary housing comprises an arc-shaped insertion portion, which is inserted into and embedded in the arc-shaped receiving portion, and through which the center shaft passes,
wherein the rotary housing comprises an arc-shaped housing insertion portion at a center portion thereof,
wherein the fixed housing is inserted into the housing insertion portion and coupled to the center shaft,
wherein the arc-shaped insertion portion and the housing insertion portion are disposed coaxially with respect to the center shaft,
wherein the arc-shaped insertion portion is disposed in front of the housing insertion portion, and
wherein the arc-shaped insertion portion has a diameter which is greater than a diameter of the housing insertion portion.

19. The driving operation apparatus of claim 6,
wherein the plurality of driving operation systems comprises a left driving operation system and a right driving operation system,
wherein a connecting portion of the left driving operation system and a connecting portion of the right driving operation system, which protrude from the rotary housing, are connected to the rotary housing to protrude in a U-shape, and
wherein the connecting portions of the left and right driving operation systems are disposed radially outside the display unit to prevent the driver's hand from interfering with the display unit based on that the driver holds the handle portion.

20. A vehicle comprising:
a driving operation system comprising:
a rotary housing through which a center shaft fixed to a vehicle mounting unit passes and which is configured to rotate about the center shaft relative to the vehicle mounting unit during a steering operation;
a fixed housing fixedly coupled to the center shaft that passes through the rotary housing and disposed to be inserted into the rotary housing;
a display unit coupled to the fixed housing; and
a pair of driving operation systems disposed on opposite sides of the display unit, wherein each driving operation system includes a first end portion fixed to the rotary housing and a second end portion protruding in a predetermined direction, the driving operation systems being configured to allow a driver to perform steering, acceleration, and braking operations; and
a vehicle controller configured to generate an operation signal corresponding to a signal generated by the driving operation systems,
wherein the vehicle is driven in response to the operation signal of the vehicle controller.
